(19) United States
(12) Patent Application Publication
(10) Pub. No.: US 2007/0113245 A1
(43) Pub. Date: May 17, 2007

(54) Font library for interactive television recording and playback on a storage medium

(75) Inventors: Jingwei Tan, Shanghai (CN); Declan Patrick Kelly, Eindhoven (NL); Liang Gan, Shanghai (CN); Jun Shi, Shanghai (CN)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 10/538,631

(22) PCT Filed: Dec. 3, 2003
(86) PCT No.: PCT/IB03/05774

§ 371 Date: Jun. 10, 2005

(30) Foreign Application Priority Data
Dec. 16, 2002 (EP) 02080307.8

(51) Int. Cl. H04N 5/445

(52) U.S. Cl. 725/38

(57) ABSTRACT

A method (49, 55) of handling fonts in a recorder or a playback-recorder for interactive television. Fonts are stored on a recordable storage medium (220), wherein the fonts are part of a downloaded interactive television application. When recording, the downloaded fonts are stored separate from the application, preferably in a font library on the recordable storage medium, which preferably is a removable medium, preferably an optical storage medium. Each font is only stored in one copy, even when a plurality of applications on the storage medium need that font for running. When playing back the application from the storage medium, indicating information is provided on which fonts form the storage medium in the font library are required for playback of said application from said storage medium. Thus multiple storage of fonts is prevented, minimising needed storage space on the storage medium.

This invention relates in general to the field of interactive television and more particularly to the recording of interactive television contents and even more particularly to the font handling in the field of recording of interactive television contents.

Interactive television (iTV) is becoming more and more popular. An example for interactive television is the Multimedia Home Platform (MHP), which is a digital video broadcasting (DVB) standard intended to combine digital television (DTV) with interactivity and access to the Internet and the World Wide Web. DTV service providers offer a large variety of audio-visual (A/V) television programs and also of applications allowing the interaction of the viewer/user with the TV set and its contents. The applications are broadcast together with the A/V contents and executed in a television set adapted for this task or in a separate set top box (STB).

Similar to today's video recorders for analogue television broadcasts using video tapes for recording broadcast streams, digital video recorders for interactive television are developed using either a harddisk or removable media such as optical discs for storing recorded broadcasts. The digital video recorders for interactive television record both A/V television contents and applications for playback at a later point of time.

Interactive TV applications consist of an application program part being executed and which uses fonts when displaying characters. These fonts can be either resident in a set top box (STB) or downloaded with the application that uses them. The resident fonts in a STB are commonly called default fonts.

When recording iTV broadcast contents, in the case of downloaded fonts (i.e. fonts embedded in the broadcast transport stream), the downloaded font is currently stored along with each application program together with other files needed by the application program for running the application at a later point of time, when playing back the application. In case of Latin alphabets, the size needed for storing the font is relatively small, in the range of less than about 50 Kbytes. However, in the case of certain other alphabets, such as Asian alphabets, e.g. the Chinese alphabet, the font size is significantly larger, e.g. 2 Mbytes.

When recording the applications as mentioned above, the font is recorded together with each application as it is generally not known which fonts are available in the device executing the application, e.g. a STB. Furthermore, it is likely that a broadcaster will use the same downloadable font for multiple applications, e.g. for esthetical reasons generating the same look-and feel of the applications. Thus, when a plurality of applications is recorded, which all use the same font, the font will have to be recorded, i.e. stored, multiple times. This multiple recording of the same downloaded font data occupies a large amount of storage space on the storage media, as the amount of storage space is limited. Therefore a large portion of the storing media is used for fonts, especially when each font has a large size, or when the number of files, i.e. the number of fonts, stored on the storage media is large. It is desirable to keep the amount of space used for applications is as low as possible, in order to be able to record as much iTV content as possible on a storage medium.

U.S. Pat. No. 6,141,002 discloses a system and method for rendering Unicode text in multiple languages on a set-top box (STB). The STB includes a set of default fonts. When the STB receives a broadcast application with a character which is not part of the default fonts, the STB checks the fonts available through the download application and uses the download font instead. The downloaded font is then stored in a separate memory comprising downloaded fonts, so that the currently downloaded font glyph is available in the future. This method has the drawback that, when the A/V content and the application are to be recorded on a removable medium, such as an optical disc, the font has to be recorded on the disc together with the application. This is due to the fact that the recorded removable medium might be played on another recorder than the one on which it was recorded on. This means that even when the STB has the necessary font in a memory, as disclosed by U.S. Pat. No. 6,141,002, the font still has to be stored on the disc, at least if the disc is removable. Furthermore the font information is stored independent of any application, thus generating a memory space problem with an increasing number of fonts to be stored, i.e. a plurality of fonts will be resident in the font download memory which are not needed for any current application. As the download memory is physically limited, the STB runs out of available download memory. Therefore the problem of keeping the amount of space used for applications as low as possible is not solved by the disclosed system and method.

It is an object of the invention to keep the amount of space used for applications as low as possible, in order to be able to record as much iTV content as possible on a storage medium.

A more detailed definition of the terms used in this disclosure is given below for a better understanding.

A set-top box (STB) is a device which enables a television set to receive and decode digital television (DTV) broadcasts with an existing analogue television set. A STB may also allow a television set to become a user interface to the Internet. Sophisticated set-top boxes contain a hard drive for storing recorded television broadcasts, for download software and for other applications provided by a DTV service provider.

A font is a set of printable or displayable text characters in a specific style and size.

A character is a printable symbol having phonetic or pictographic meaning and usually forming part of a word of text, depicting a numeral, or expressing grammatical punctuation. A character can be distinguished from other characters in terms of meaning and sound.

The present invention overcomes the above-identified deficiencies in the art and solves the above problems by providing according to one aspect of the invention, a method of handling fonts in a recorder or a playback-recorder for interactive television, wherein said fonts are stored on a recordable storage medium, such as a recordable DVD. The fonts are part of a downloaded interactive television applications, and the method comprises, in the case of recording interactive television contents, the step of storing the downloaded fonts separate from the application program in a font library on the recordable storage medium. Each font is only stored once on a storage medium. When playing back the application, according to another aspect of the invention, a method comprises the step of indicating which font or fonts of the font library comprising a plurality of fonts on the storage medium are required for playback of said application from said storage medium and subsequently choosing a font for said application and then merging the chosen font with the application program.

According to another aspect of the invention, an apparatus which is used for recording and/or playing back interactive television contents, wherein said apparatus comprises a font handling device. This font handling device is adapted for use in said apparatus. Fonts being part of downloaded interactive television applications are stored on a recordable storage medium. The fonts are stored separate from the application in a font library on said recordable storage medium, and whereby each font is only stored in one copy.

According to yet another aspect of the invention, a computer readable medium is disclosed, which comprises instructions for performing the above method, wherein the computer readable medium contains thereon a computer program for processing by a computer. The computer program comprises a code segment for storing downloaded fonts from interactive television applications on a storage medium, wherein said code segment instructs the computer to store only one copy of different fonts in said font library.

A further aspect of the invention is a storage medium for interactive television comprising a separate font library and a separately stored application module. The storage medium comprises at least two interactive television applications recorded on it. The applications are stored separate from the fonts needed for running said applications. The storage medium further comprises a font library which comprises fonts, whereby the font library does not comprise more than one copy of each of the fonts needed for running all applications stored on the storage medium.

Downloaded fonts are stored separately from applications in a font library on the iTV storage media. Each font is only stored once, even if it is used with multiple applications.

According to a preferred embodiment of the invention, the iTV application is during recording parsed for fonts, which it includes. The fonts are then removed from the application module. If the fonts are already downloaded, i.e. if the fonts are already stored in the font library on the storage medium, preferably a removable medium, the downloaded copy of the fonts is disregarded. In the other case, the downloaded font is stored in the font library on the storage medium. The modified application module without the font is stored on the storage medium.

For playback, an info file indicates which fonts are required for playback of the application. The fonts are loaded from the font library and merged with the application program and the other application files for running the recorded application.

Thus, the invention solves the problem that fonts use an unnecessarily large amount of storage space on a storage medium in the case of multiple iTV applications using the same font.

These and other aspects of the invention will be apparent from and elucidated with reference to the drawings and the embodiments described hereinafter.

A number of exemplary embodiments of the present invention will be described in the following detailed disclosure, reference being made to the accompanying drawings, in which

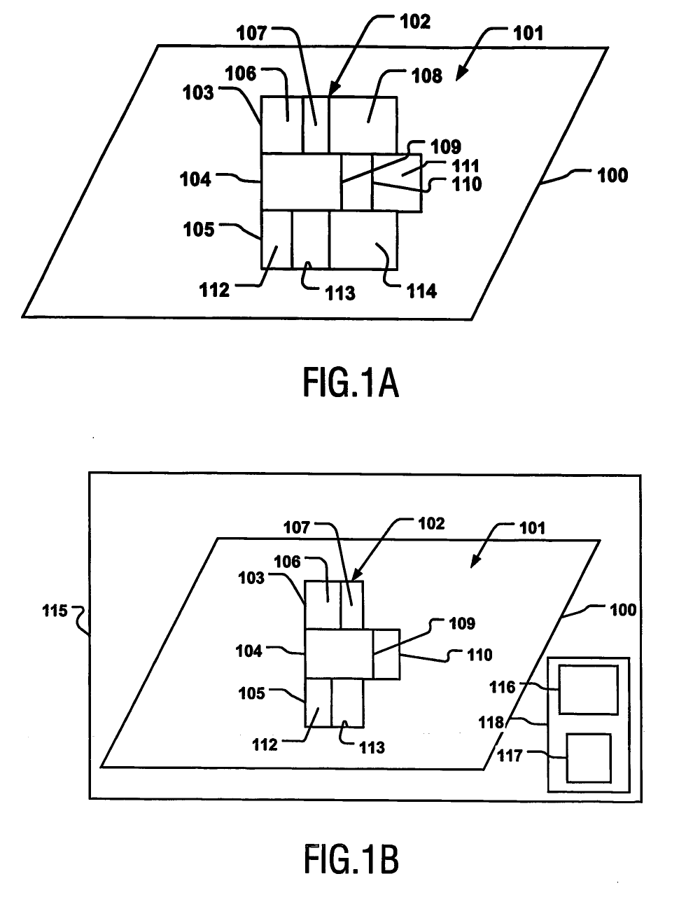

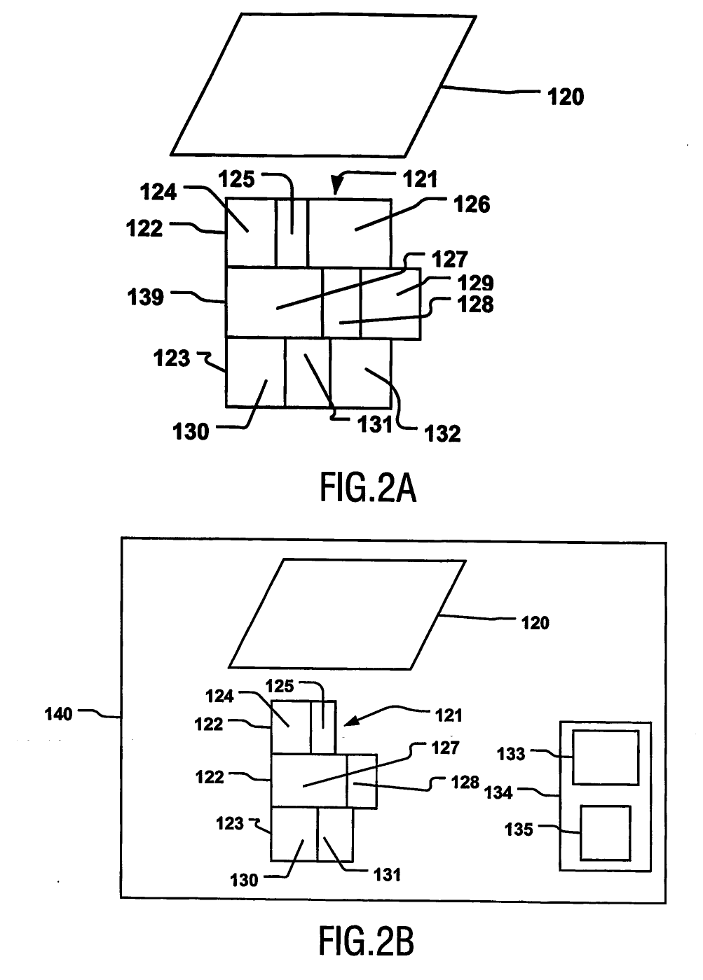

FIGS. 1A, 2A 3A and 11A show schematic diagrams over iTV structures to be recorded,

FIGS. 1B, 2B 3B and 11B show schematic diagrams over iTV recordings of the structures from FIGS. 1A, 2A, 3A and 11A, each including a font library, according to embodiments of the invention,

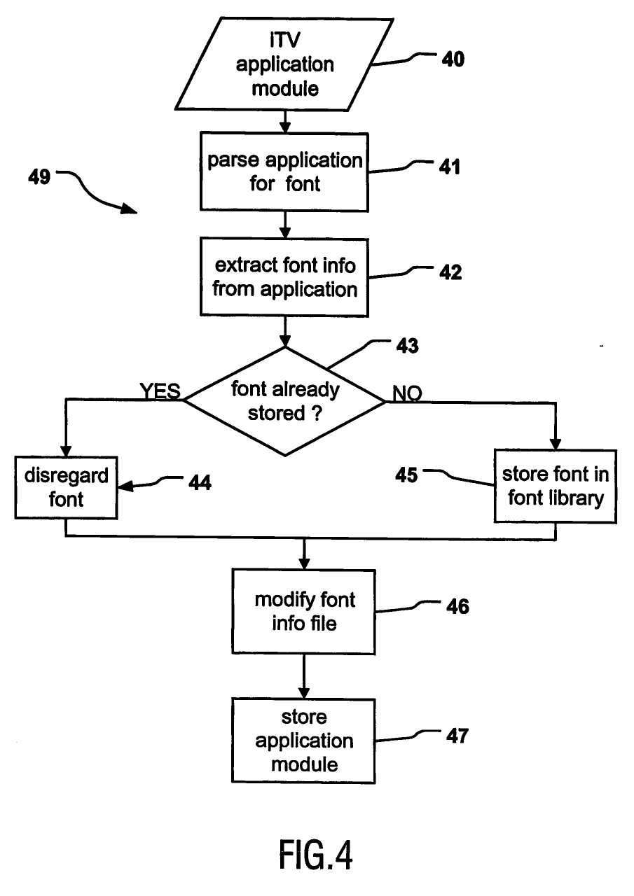

FIG. 4 illustrates in a flowchart the recording of interactive television applications according to an embodiment of the invention,

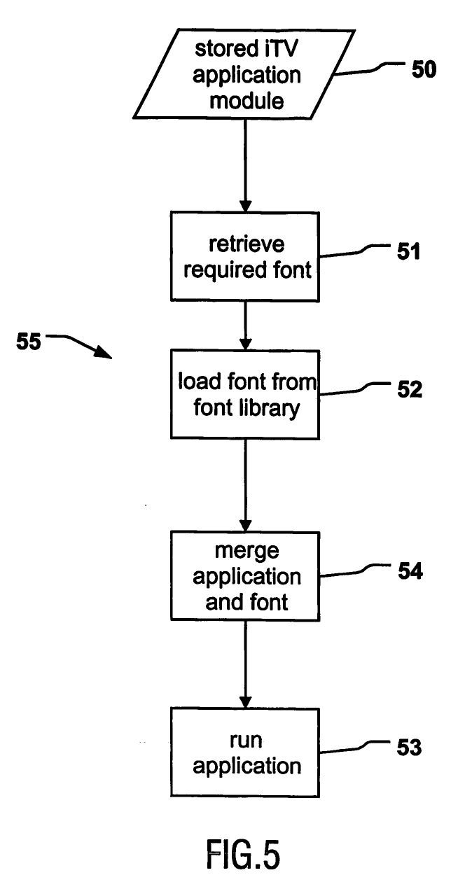

FIG. 5 shows a flowchart over the playback of interactive television applications according to an embodiment of the invention,

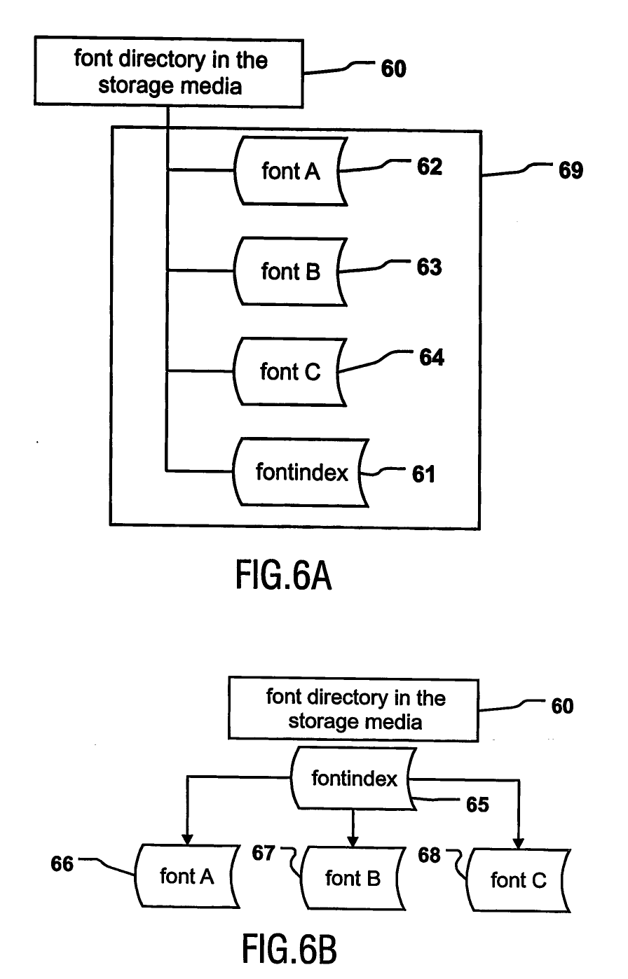

FIGS. 6A and 6B are schematic diagrams over alternative examples of a font library structure of an embodiment of the invention,

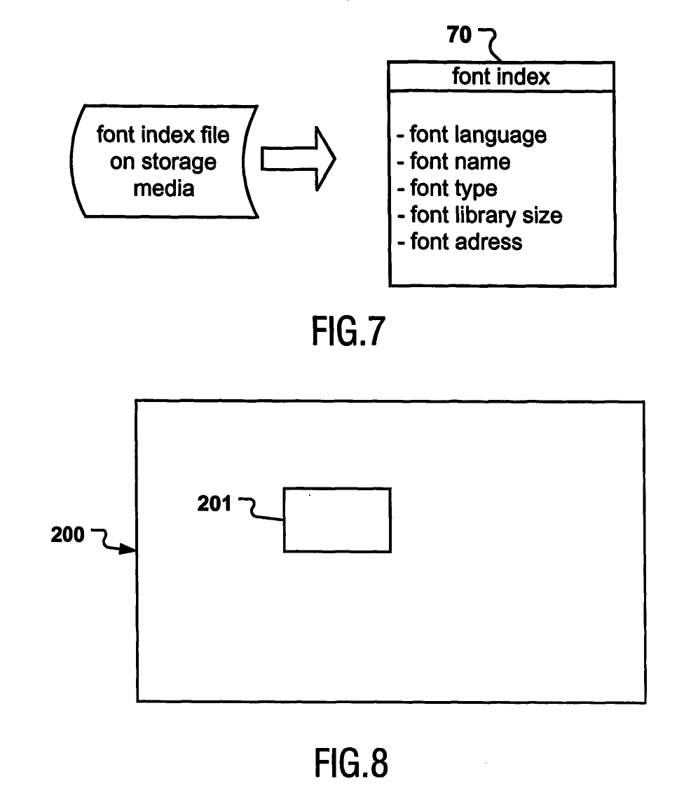

FIG. 7 illustrates in a schematic diagram an exemplary font index structure of an embodiment of the invention,

FIG. 8 shows a schematic diagram over an iTV recording device according to a preferred embodiment of the invention,

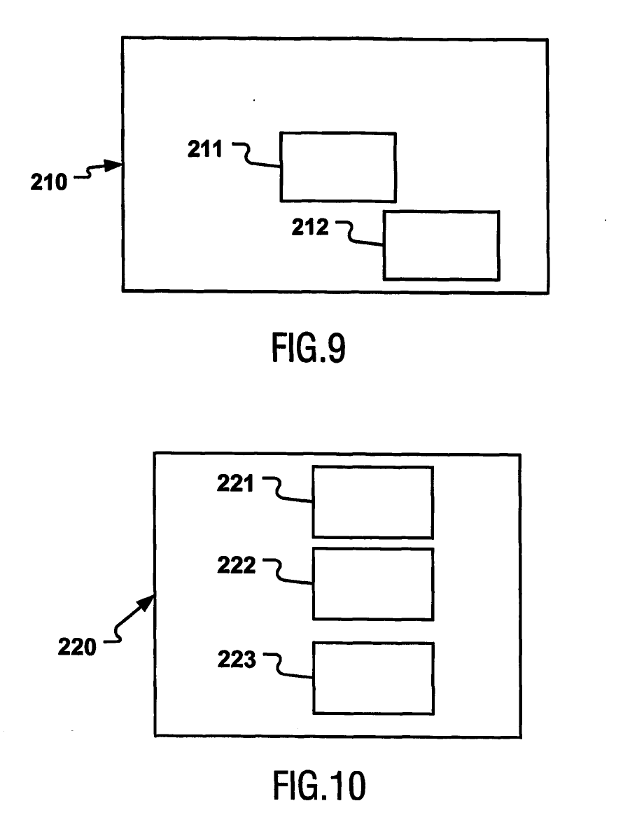

FIG. 9 shows a schematic diagram over a computer readable medium according to another preferred embodiment of the invention, and

FIG. 10 shows a schematic diagram over a storage medium according to a further preferred embodiment of the invention.

Generally, an iTV broadcast includes a number of files, some of which are applications, generally consisting of executable code in Java, and some are data files including the above mentioned font files. The application indicates generally the font to be used for running the application program. For receiving and displaying the iTV application on a TV set, the font has either to be available in the Set Top Box, either as a default font or as a downloaded and in the STB stored font, or else the font has to be included as a file in the broadcast. When storing the application on a storage medium for being played back at a later point of time, the fonts used by the application must also be stored. According to the invention, the fonts are stored in a font library on the storage medium instead of with the specific application that uses them. Thus, the application has not to be modified, e.g. for pointing at a specific font file location. The necessary font files are stored in a separate location on the storage medium, which preferably is an optical disc and it is ensured that there is no duplication of font files in the font library. On playback the font library is searched for the fonts the application wants to use. This principle of the invention will be described in more detail by the following description of embodiments of the invention.

In FIG. 1A an iTV broadcast stream 100 according to the state of the art is shown. The broadcast stream comprises both iTV clip A/V contents 101 and applications 102. In this example three applications 103, 104 and 105 are depicted. Bach application comprises an application program 106, 109, 112, as well as fonts 108, 111, 114 and optionally further application files 107, 110, 113 which are needed for running the application. In the example shown, fonts 108 and 114 are identical and it can be seen that the same font is comprised twice in the broadcast stream 100, in different applications 103 and 105. According to FIG. 1B the broadcast stream 100 of FIG. 1A is shown in a recorded state on a storage medium 115. According to the invention, the downloaded fonts 108, 111, 114 are stored separate from the application in a font library 118 as font modules 116 and 117 on the recordable storage medium 115, wherein recorded font 116 corresponds to streamed application fonts 108 and 114 and recorded font 117 corresponds to streamed font 111. In this example, the space needed to store font 114 is saved for other storage purposes on the storage medium 115.

In practice, if two applications in the same broadcast use the same font then it only needs to be broadcast once. Generally, the broadcast comprises a set of files being broadcast within the same broadcast section. In the special case, that two applications are broadcast simultaneously in the same broadcast, these applications can use the same font file from the same broadcast. On the other hand, if an application is broadcast at a later point of time and this application uses the same font as an earlier broadcast application, the font is comprised in both broadcasts, without the exception for the below described case of a separate return channel, in which the subsequent download of a font file already being stored on the storage medium can optionally be avoided. According to the invention, the font file is only recorded once on a storage medium, independently to how often it is transmitted with an iTV broadcast which is to be recorded on a storage medium and independently to how many applications using the same font are recorded on the same storage medium.

In FIG. 2A an iTV broadcast stream 120 according to the state of the art is shown. Besides the broadcast stream comprising iTV clip A/V contents, applications 121 are stored separately. In this example three applications 122, 139, 123 are depicted. Each application 122, 139, 123 comprises an application program 124, 127, 130, as well as fonts 126, 129, 132 and optionally further application files 125, 128, 131 which are needed for running the application. In the example shown, fonts 126 and 132 are identical and it can be seen that the same font is comprised twice among the applications 121, in different applications 124 and 123. According to FIG. 2B the broadcast stream 120 of FIG. 1A together with applications 124, 139, 123 are shown in a recorded state on a storage medium 140. According to the invention, the downloaded fonts 126, 129, 132 are stored separate from the application in a font library 134 as font modules 133 and 135 on the recordable storage medium 140, wherein recorded font 133 corresponds to downloaded application fonts 126 and 132 and recorded font 135 corresponds to streamed font 129. In this example, the space needed to store font 132 is saved for other storage purposes on the storage medium 115.

Applications can also be downloaded over a separate return channel, e.g. via an Internet connection, as well as being included in the broadcast. The invention applies equally when this is done. In this case the font library can optionally be checked if the font required by the current application is already stored in the font library on the storage medium. If the font is already stored, the font does not have to be downloaded over the return channel, such as the mentioned Internet connection, and it is avoided that the font file is downloaded. This is advantageous both regarding connection cost and/or bandwidth of the return channel.

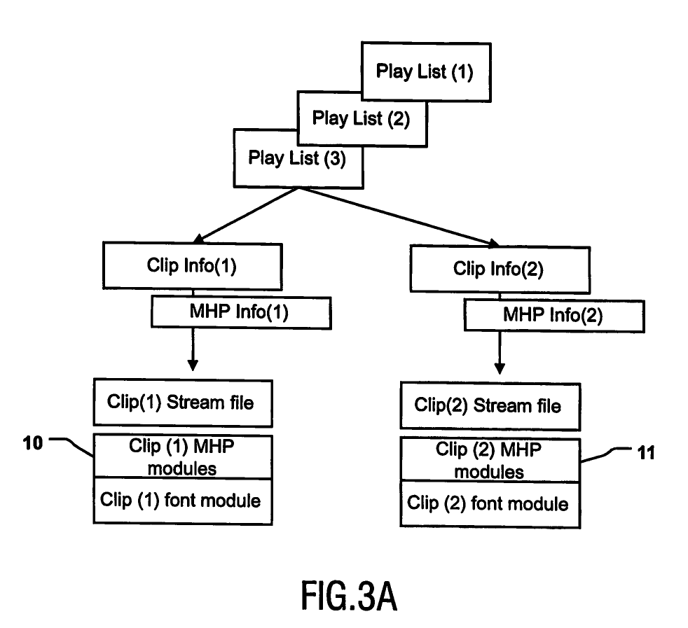

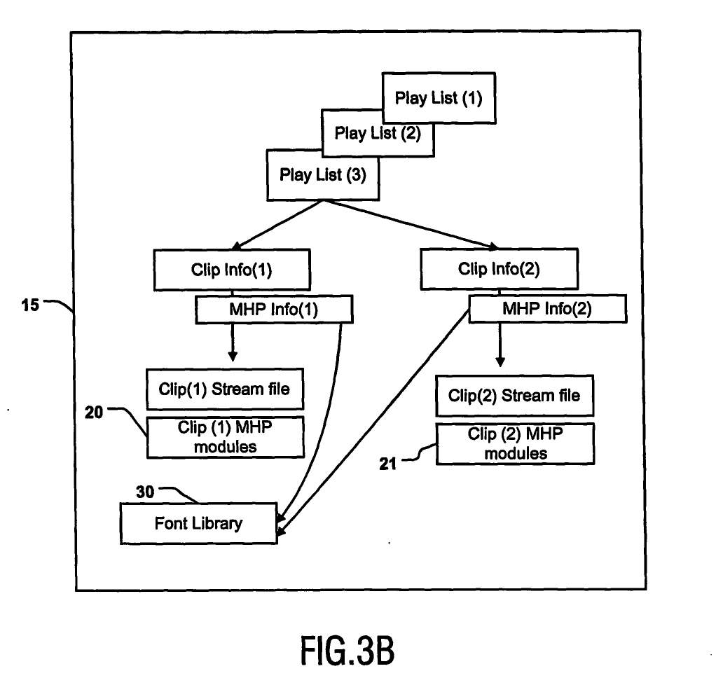

FIG. 3A shows another iTV recording structure, especially for, but not limited to, MHP recording, wherein downloaded fonts are stored in MHP module files 10,11 according to FIG. 1. Each iTV clip comprises it's own MHP module file including the parts of the broadcast that relate to the MHP application. This file will include any fonts in the broadcast stream. Thus, each clip is stored with its own font module, which leads to the above described problems.

FIG. 3B shows a modified structure of FIG. 3A, according to an embodiment of the invention, recorded on a storage medium 15. The MHP modules do no longer include the fonts. Each font is only stored once in a font library 30, even if used with multiple applications. In the shown diagram, the MHP modules 20, 21 do no longer include the fonts needed for running the MHP applications of the clips. In FIG. 2, two exemplary clips are depicted, wherein the two clip's applications are run with the fonts loaded from the font library 30.

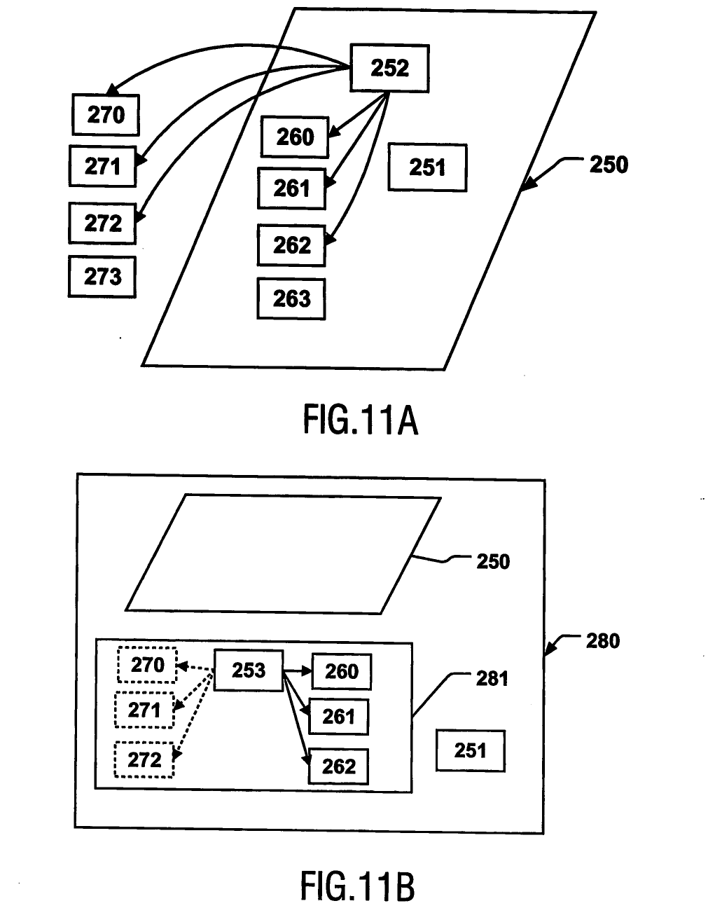

FIG. 11A shows another iTV recording structure, wherein an application 251, such as an MHP application, uses some of fonts 260, 261, 262, 263, 270, 271, 272, 273. The application is shown as included in the broadcast transport stream (TS) 250, but it is as well applicable that the application 251 is downloaded via another communication channel, as described above. Fonts 260, 261, 262, 263 are transmitted with the broadcast TS, whereas fonts 270, 271, 272, 273 are stored in another location, e.g. as default fonts in a STB. The number of fonts 260, 261, 262, 263, 270, 271, 272, 273 is only for illustrative purposes limited to four. In this special case, the application module does not indicate information in a separate file on which font or fonts it needs for running. Instead, a fontindex file 252 is comprised in the broadcast, which gives a mapping from font names, which are used in an application to font files, as illustrated in FIG. 11A. Furthermore, the fontindex file 252 does not indicate which particular application does use which particular fonts, but does allow a STB to find the font, a application is looking for. In a MHP broadcast TS, the fontindex file 252 usually contains information on fonts which are not default fonts and which thus generally are not available as default fonts resident in a STB, i.e. the fontindex file 252 contains information on fonts which an application 251 comprised in the TS needs for running, but which most likely will not be available as already stored in a STB receiving the TS. When the fontindex file 252 is downloaded together with an application 251, it generally contains only information on fonts needed by that application 251. The fontindex file 252 might also contain information on other fonts, but in practice this will not be the case. On the other hand, when a further application (not shown) is broadcast, and this application uses another font which is not a STB default font, the application attaches its new font to fontindex file 252.

When recording the application and fonts, it is thus not possible to extract information on which fonts are to be recorded with the application. This information is only given as a font name when the application is run. According to an embodiment of the invention, it is compared which fonts are listed in the fontindex file 252 and which fonts actually are in the broadcast and the respective other locations, as described above. Only font files which are listed in the font index file 252 and which are not already stored on a storage medium 280 on which the application 251 is to be recorded, are recorded on that storage medium 280. A possible recording is thus illustrated in FIG. 11B. Fonts 263 and 273 are not recorded as fontindex file 252 according to FIG. 11A does not contain mapping to these fonts. Fonts 260 to 262 are recorded. In this example, none of fonts 260 to 262 has been earlier recorded on medium 280. Furthermore, fonts 270 to 272 are illustrated with dotted lines, as these fonts are optionally recorded, when it cannot be assured, that the storage medium 280 will be played back to a STB comprising fonts 270 to 272 as default fonts. Fonts 260 to 262 and optionally 270 to 272 are in this example stored in a font library 281. Fontindex file 253 on the storage medium 280, see FIG. 11B, contains information on the new fonts stored on storage medium 280. Fontindex file 253 contains a copy of the content of fontindex file 252 from the TS, in case fontindex file 253 has previously been empty, i.e. no fonts were in the font library 281. In case font library 281 has previously not been empty, the new fonts info is added to fontindex file 253 on the storage medium 280. In the example of the fontindex file 252 in the TS having a structure according to the MHP standard, also the font index file 253 on the storage medium 280 follows the same syntax of fontindex defined by MHP. Fontindex file 253 generally contains information on all fonts which are stored on the storage medium 280. Specifically, each time new fonts are stored on the storage medium 280, the information related to these new fonts is added to fontindex file 253. In the above mentioned case, of a further application (not shown) in the broadcast TS 250 having attached its font to fontindex file 252, the fontindex file 253 will contain information on fonts for both application, when. both application and their fonts are stored on storage medium 280.

In another embodiment of the invention according to FIG. 4, a method 49 is illustrated, for recording an iTV application module 40. The module 40 comprises a font needed for running the application. In step 41, the application module 40 is parsed for the font comprised in the module. Furthermore, the font information, i.e. the information on which font file is needed for running the application, is extracted from application module 40 in step 42. Subsequently, in step 43 it is checked if the font which is indicated by the information extracted in step 42 is already stored on the storage medium. In this embodiment, fonts are stored in a font library on the storage media. Thus, if the font required by application module 40 is already present and stored in the font library, it is discarded in step 44. In the other case, i.e. the font required by the application identified as a new font which is not yet stored in the font library, and the new font is stored in the font library in step 45. Subsequently, the font info file of the font library is modified in step 46 in such a way, that it comprises information on where on the storage medium, i.e. in this case where in the font library, the font needed for running the application is found, e.g. by indicating a font file name and a directory name. Finally, the application module, i.e. the application program and other files except the font files required for running the application program, is stored in step 47 and recording of the application is concluded.

It should be noted that in the MHP standard, the font library's location according to the MHP application has been defined. The application provides a font info file for the fonts the application may use. The font info file stored in the storage media is used to describe all the fonts stored in the storage media. Preferably its structure is the same as the one in the application module. Only the content and size is different from the one in the broadcast stream.

When, at a later point of time, playing back the recorded application module from the storage medium, the application module indicates which font is needed for running the application program. In this case it is checked where the required font is in the font library and/or if the required font is a default font.

Fonts can be deleted that are no longer used when all recordings of applications requiring this specific font are deleted from the storage medium, thus making the storage space of this font available for other purposes.

In another embodiment of the invention, the step 44 is replaced by a step wherein the stored font—in the font library on the storage medium—is replaced by the font in the received iTV application module.

A further embodiment of the invention is illustrated in FIG. 5. FIG. 5 illustrates the playback case of an iTV application module 50 stored on a recordable storage medium, such as a recordable DVD. In step 51 of the method 55, the information which font is required is retrieved/extracted from the application. The information can e.g. be stored in the MHP info file, as described above. This font is loaded in step 52 and merged with the application module in step 54. Subsequently the application is run in step 53 using the required font, retrieved from the font library in step 51.

In. FIGS. 6A and 6B, alternative examples of a font library structure of an embodiment of the invention are shown. In FIG. 6A, a structure is described, wherein the fonts 62, 63, 64 are stored in a single file 69 in a font directory 60. A font index 61 is also part of the font file 69. The content of file 69 is built by the font files from the broadcast concatenated. A single file is of advantage when am increasing number of files is a problem, which is the case for some file systems.

According to FIG. 6B, the font files 66, 67, 68 are stored in separate individual files and a font index comprises information on where to retrieve the stored fonts. Preferably the font index comprises additional information on the fonts, according to FIG. 7.

In either case the fonts are preferably stored in the same format as used for broadcast. However, further minimisation of used storage space can be achieved by compressing the font files appropriately.

FIG. 7 shows a preferred structure for a font index 70 of an embodiment of the invention. For every application that needs a font from the font library, it has to be checked where the font is located in the font library. For checking, a fond index structure is defined, comprising information on font language, font name, font type, font library size and font address. The font address indicates where the font is on the storage medium. If the font library is stored in a single file, this address information is defined as an offset within the font file. If each font is stored in a separate file, then the file name including the path is stored. As the language used for the program can be derived from the broadcast stream, it is in the given example assumed, that the application linked to this program also uses this language. The font index, in form of a table, see below, is searched for the language first, which fastens up search speed. For example, if the language for a program is known as Chinese, we go directly to the Chinese table for locating the font by comparing the font name. Below, an example for a font indexing structure is given in the following table.

| Language | Font name | Font Type | Font Library Size | |
|---|---|---|---|---|
| English | Tiresias | PFR | 9 | KB |
| | Humnst777 BT | PFR | 17 | KB |
| | Monospac821 BT | PFR | 18 | KB |
| Chinese | Simhei | PFR | 2.1 | MB |
| Dutch | Dutch801 RM BT | PFR | 36 | KB |
| Swiss | Swiss721 BT | PFR | 25 | KB |
| Other | | | | |

By way of example, the list for other languages is empty.

FIG. 8 shows a schematic diagram over an iTV recording apparatus 200 according to a preferred embodiment of the invention. Apparatus 200 comprises a font handling device 201, wherein fonts being part of downloaded interactive television applications are in use of said device being stored on a recordable storage medium. The fonts are stored separate from the application in a font library on said recordable storage medium and each font is only stored in one copy according to the invention, even if multiple applications require the same font.

FIG. 9 shows a schematic diagram over a computer readable medium 210 according to another preferred embodiment of the invention. The computer readable medium 210 comprises a computer program 211 for processing by a computer 212. The computer program 211 comprises a code segment for storing downloaded fonts from interactive television applications on a storage medium, and the code segment instructs the computer 212 to store only one copy of different fonts in said font library.

FIG. 10 shows a schematic diagram over a storage medium 220 according to a further preferred embodiment of the invention. The storage medium 220 for storage of interactive television comprises at least two applications 221 recorded on said medium 220. The applications are stored separate from fonts needed for running the applications. The storage medium 220 further comprises a font library 222. The font library 222 comprising fonts and the font library comprises not more than one copy of each of the fonts needed for running all applications 221 stored on the storage medium 220. In practice, the number of fonts stored on the storage medium is thus dramatically reduced.

The present invention has been described above with reference to specific embodiments. However, other embodiments than the preferred above are equally possible within the scope of the appended claims, e.g. different font storage methods than those described above, different file storing structures than those described above, different ways of transporting the application along with the broadcast stream, number of applications or fonts, performing the above method by hardware or software, using glyphs instead of fonts, being implemented in any form of interactive TV, such as MHP, OpenTV, Digital TV Application Software Environment (DASE), or using alternative storage media such as DVD, SFFO (Small Form Factor Optical Storage, etc. Furthermore an application might use a plurality of fonts. According to the invention, not more than one copy of each single of this plurality of fonts is stored on a storage medium.

Furthermore, the term “comprising” does not exclude other elements or steps, the terms “a” and “an” do not exclude a plurality and a single processor or other unit may fulfil the functions of several of the units or circuits recited in the claims.

The application may be summarised as a method (49, 55) of handling fonts in a recorder or a playback-recorder for interactive television. Fonts are stored on a recordable storage medium (220), wherein the fonts are part of a downloaded interactive television application. When recording, the downloaded fonts are stored separate from the application, preferably in a font library on the recordable storage medium, which preferably is a removable medium, preferably an optical storage medium. Each font is only stored in one copy, even when a plurality of applications on the storage medium need that font for running. When playing back the application from the storage medium, indicating information is provided on which fonts form the storage medium in the font library are required for playback of said application from said storage medium. Thus multiple storage of fonts is prevented, minimising needed storage space on the storage medium.

1. A method of handling fonts in a recorder for interactive television, wherein said fonts are stored on a recordable storage medium, said fonts being part of interactive television applications, said applications comprising at least an application program and at least a font, said method comprising the step of
storing said downloaded font separate from the application on said recordable storage medium, whereby each font is only stored once on said recordable storage medium.

2. A method according to claim 1, wherein said applications comprise application modules comprising application programs and fonts.

3. A method according to claim 1, wherein said downloaded font is stored in a font library.

4. A method according to claim 1, further comprising the steps of
parsing said application for included font data indicating at least one font required for running said application,
separating said application and said font from the download stream,
storing said font data and said font as a new font in said font library, in case the font is not already stored in said font library,
disregarding the font in the other case, and
storing the application module without the font on the storage medium.

5. A method according to claim 1, wherein said font library comprises individual files.

6. A method according to claim 5, wherein said font library consists of a single file.

7. A method according to any of the preceding claims, wherein said font library is indexed by a font index preferably comprising data on font language, font name, font type, font library size and font location information of the fonts in said font library.

8. A method according to claim 1, further comprising the step of
recording all fonts indicated in a fontindex file of an iTV broadcast, except for those fonts already stored on said storage medium.

9. A method according to any of the preceding claims, wherein the recordable storage medium is a removable storage medium.

10. A method according to claim 7, wherein the removable storage medium is an optical disc.

11. A method according to any of the preceding claims, wherein said interactive television is MHP, OpenTV or DASE.

12. A method according to any of the preceding claims, wherein the font is Chinese.

13. A method according to claim 4, wherein said font data stored in said font library comprises information on the path location or sequential location of said required font in said font library.

14. A method according to claim 4, wherein said font data stored in said font library comprises information on the name of said required font enabling locating of font required for running an application program.

15. A method according to claims claim 1, further comprising the steps of
parsing said application for included font data indicating at least one font required for running said application,
separating said application and said font from the download stream,
storing said font data and said font as a new font in said font library, in case the font is not already stored in said font library,
replacing the font already stored in the font library by the font separated form the download stream in the other case, and
storing the application module without the font on the storage medium.

16. A method of handling fonts in a playback-recorder for recorded storage media, said media comprising interactive television to be playbacked, said fonts being stored in a font library on said recordable storage media, and said fonts being part of a recorded interactive television application, comprising the steps of
indicating which fonts in said font library are required for playback of said application from said storage media,
merging said required fonts with an application being stored on said storage media for running said application.

17. An apparatus for recording and/or playing back interactive television, said apparatus being adapted to record and playback interactive television to and from a storage medium respectively, said apparatus comprising
a font handling device, said font handling device being adapted for said apparatus, wherein fonts being part of downloaded interactive television applications are in use of said device being stored on said recordable storage medium, and wherein said fonts are stored separate from the application on said recordable storage medium, and whereby each font is only stored in one copy.

18. A computer readable medium having embodied thereon a computer program for processing by a computer, the computer program comprising:
a code segment for storing downloaded fonts from interactive television applications on a storage medium, wherein said code segment instructs said computer to store only one copy of different fonts in said font library.

19. Use of the method according to claim 1.

20. A storage medium for interactive television comprising
at least two interactive television applications recorded on said storage medium, said applications being stored separate from fonts needed for running said applications, and
at least two of said interactive television applications using the same font,
whereby not more than one copy of each font is stored on said storage medium.
